(19) United States
(12) Patent Application Publication
(10) Pub. No.: US 2026/0061936 A1
(43) Pub. Date: Mar. 5, 2026

(54) SIDESTEP BRACKET ATTACHMENT

(71) Applicant: FCA US LLC, Auburn Hills, MI (US)

(72) Inventors: Aslam Adam, Auburn Hills, MI (US); Kivin Roberto Lee Lewis, Auburn Hills, MI (US); Andrew Lee Partin, Auburn Hills, MI (US); Yelena Lisovskaya, Auburn Hills, MI (US)

(21) Appl. No.: 18/820,459

(22) Filed: Aug. 30, 2024

(51) Int. Cl. B60R 3/00

(52) U.S. Cl. CPC B60R 3/002

(57) ABSTRACT

A sidestep for a vehicle has a tread plate. At least one bracket supports the tread plate. The at least one bracket has a hoisting plate to provide a surface where a jack or the like may contact the vehicle. Fasteners couple with the bracket to secure the bracket to the vehicle.

### FIELD

The present disclosure relates to vehicles and, more particularly, to vehicles including a sidestep that includes a bracket to attach it to the vehicle sill.

### BACKGROUND

This section provides background information related to the present disclosure which is not necessarily prior art.

In the automotive industry, various types of vehicles exist. Generally, as the vehicles get larger, such as vans, trucks, SUVs or the like, the vehicles are higher off the ground. Thus, manufacturers have begun to place running boards or steps on the side sill or rocker panels to enable access into the vehicle. Various types of sidesteps exist to enable occupants to enter into the vehicle. Generally, the sidesteps have been secured to the sill to enable the occupants to enter into the vehicle.

In these vehicles, there is ordinarily a hoist or jack reinforcement that is positioned onto the sill under the vehicle. These hoisting or jacking reinforcements are generally behind the front wheel well and in front of the rear wheel well. These hoisting and jacking reinforcements are secured directly to the vehicle.

The present disclosure provides the vehicle with a sidestep that includes brackets that attach to the vehicle at the hoisting or jacking locations. The present disclosure provides a sidestep bracket with a hoisting reinforcement to reduce additional parts and weight. The present disclosure provides a sidestep that is relatively wide to provide space for the hoisting reinforcement. The present disclosure provides a sidestep with a bracket that includes a hoisting surface plate.

### SUMMARY

This section provides a general summary of the disclosure, and is not a comprehensive disclosure of its full scope or all of its features.

According to the present disclosure, it is an object of the disclosure to provide a sidestep for a vehicle comprising a tread plate and at least one bracket to support the tread plate. The at least one bracket includes a hoisting plate to provide a surface where a jack or the like may contact the vehicle. Fasteners couple with the bracket to secure the bracket to the vehicle. A cladding member covers the thread plate. The hoisting plate includes a flange to secure the hoisting plate with the vehicle. The hoisting plate includes a projecting beam to be received by the jack. Generally, there are two brackets on the tread plate. Each bracket has an overall U-shape with L-shape legs to provide a spaced or raised web to receive the hoisting plate. Each leg includes a securement flange to couple with the tread plate. At least one L-shape secondary support bracket secures with the tread plate and with the vehicle.

According to a second object of the disclosure, a vehicle with a sidestep comprises a vehicle body including a rocker panel or sill. A sidestep is secured to the vehicle adjacent the rocker panel at the sill. The sidestep includes a tread plate and at least one bracket to support the tread plate. The at least one bracket includes a hoisting plate to provide a surface where a jack or the like may contact the vehicle. Fasteners couple with the bracket to secure the bracket to the vehicle. A cladding member covers the thread plate. The hoisting plate includes a flange to secure the hoisting plate with the vehicle. The hoisting plate includes a projecting beam to be received by the jack. Generally, there are two brackets on the tread plate. Each bracket has an overall U-shape with L-shape legs to provide a spaced or raised web to receive the hoisting plate. Each leg includes a securement flange to couple with the tread plate. At least one L-shape secondary support bracket secures with the tread plate and with the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of a sidestep secured with the vehicle.

FIG. 2 is an exploded view of the sidestep.

FIG. 3 is a bottom perspective view of the bracket.

FIG. 4 is a top perspective view of the bracket.

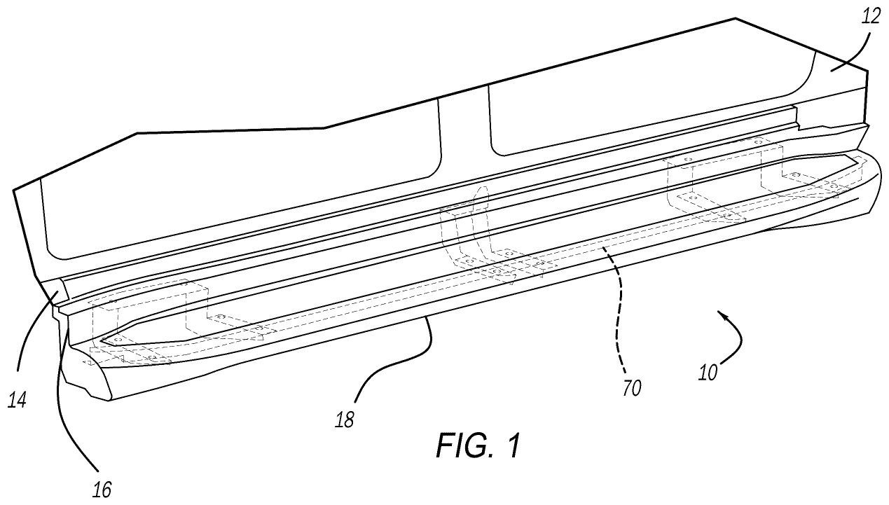

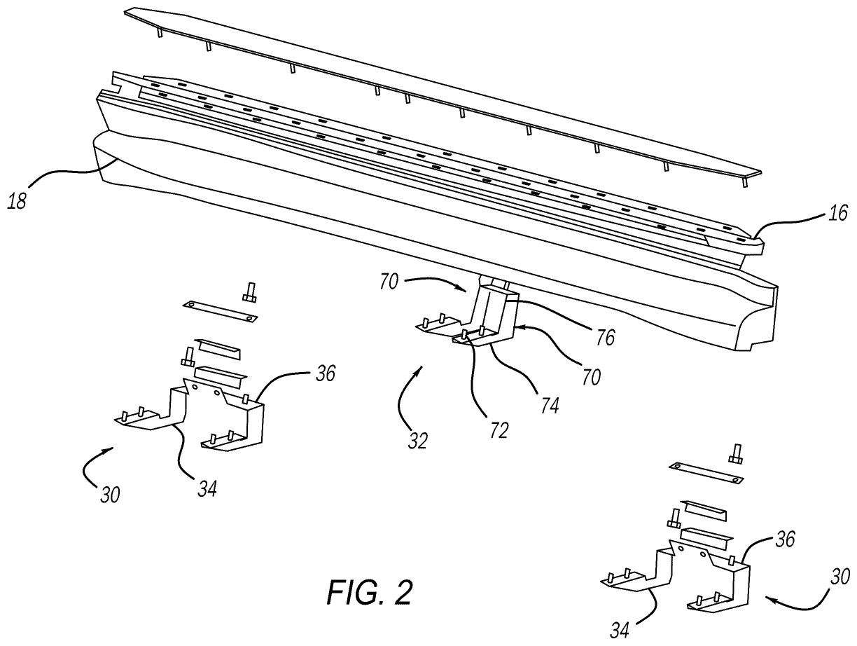

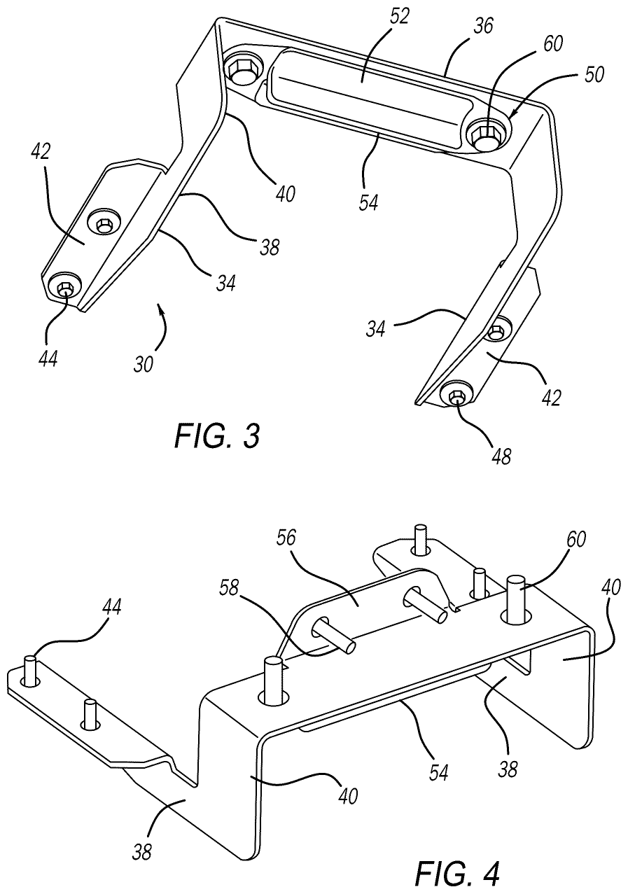

Corresponding reference numerals indicate corresponding parts throughout the several views of the drawings.

### DETAILED DESCRIPTION

Example embodiments will now be described more fully with reference to the accompanying drawings.

Turning to the figures, a sidestep 10 is illustrated secured to a vehicle 12. The sidestep 10 is secured to the vehicle 12 adjacent the rocker panel 14 and is secured with the sill 16.

The sidestep 10 includes a plastic cladding member 18 surrounding the internal parts of the sidestep to provide a pleasing aesthetic appearance for the sidestep 10. A tread plate 20 is positioned inside of the cladding member 18. The tread plate 20 provides a stepping surface for the occupant to enter into the vehicle 12. The tread plate 20 generally extends from one end of the cladding 18 to provide a step along the door or doors for a person to enter the vehicle 12. The tread plate 20 is secured to the vehicle sill 14 by at least one, preferably two, hoist brackets 30 and a secondary support bracket 32.

The hoist brackets 30 are identical to one another and one will be described to describe both. The hoist bracket 30 has an overall U-shape with a pair of L-shape legs 34 and a web 36. The web 36 is spaced or raised from the long leg 38 of the L-shape by the short leg portion 40 of the L-shape legs 34. The bracket 30 is generally a one piece stamped part with the web 36 continuous with the L-shaped legs 34. The long leg portion 38 of the leg 34 includes a flange 42 that receives fasteners 44 to secure the bracket 30 with the tread plate 20. The short leg portion 40 of the L-shaped legs 34 extends to the web 36.

The web 36 includes a hoist plate 50. The hoist plate 50 has a body 52 with a beam 54. Also, the hoist plate 50 includes a flange 56 to secure the hoist plate 50 with the sill 16. Thus, the hoist plate 50 is L-shaped with the body 52 secured to the bottom of the web 36 and the flange 56 projecting in front of the web 36 to enable securement with the sill 16 via the fasteners 58. The body 52 is secured to the web 36 via fasteners 60 passing through apertures in the hoist plate 50. The beam 54 projects from the body 52. The beam 54 can be received into the jack or the like coupling mechanism to enhance the securement of the jack with the hoist plate 50.

The hoist brackets 30 are positioned behind the front wheel well and in front of the rear wheel well to provide the hoisting surfaces for a jack or the like. Thus, the hoisting surface is added to the bracket and thus eliminates an additional part that would be welded or the like to the vehicle. Thus, the sidestep 10 provides hoist surfaces for the vehicles 12 as it is attached to the vehicle.

The secondary bracket 32 includes a pair of L-shape members 70. Each L-shape member has a flange 72 on the long leg 74 with the short leg 76 being attached to the sill 16. This provides an intermediate bracket between the two hoisting brackets 30 to provide additional support and reinforcement for the tread plate 20 and the sidestep 1. The flange 72 receives fasteners to secure the brackets 70 with the tread plate 20.

Thus, the present sidestep 10 reduces the number of parts and weight by combining the hoist plate 50 in the sill 14 outer with a sidestep bracket 30. Thus, this eliminates the hoisting rear pad and provides it with the sidestep bracket.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sidestep for a vehicle comprising:
a tread plate;
at least one bracket for supporting the tread plate, the at least one bracket including a hoisting plate for providing a surface where a jack or the like may contact the vehicle; and
fasteners coupling with the bracket for securing the bracket to the vehicle.

2. The sidestep for a vehicle of claim 1, further comprising a cladding member covering the tread plate.

3. The sidestep for a vehicle of claim 1, wherein the hoisting plate including a flange to secure the hoisting plate with the vehicle.

4. The sidestep for a vehicle of claim 3, wherein the hoisting plate includes a projecting beam to be received by the jack.

5. The sidestep for a vehicle of claim 1, wherein two brackets are included.

6. The sidestep for a vehicle of claim 1, wherein each bracket has an overall U-shape with L-shaped legs providing a spaced web to receive the hoisting plate, and each leg including a securement flange for coupling with the tread plate.

7. The sidestep for a vehicle of claim 1, further including at least one L-shaped secondary support bracket secured with the tread plate and for securing with the vehicle.

8. A vehicle with a side step comprising:
a vehicle body including a rocker panel;
a side step secured to the vehicle body adjacent the rocker panel, the sidestep including:
a tread plate;
at least one bracket for supporting the tread plate, the at least one bracket including a hoisting plate for providing a surface where a jack or the like may contact the vehicle; and
fasteners coupling with the bracket for securing the bracket to the vehicle.

9. The vehicle of claim 8, further comprising a cladding member covering the tread plate.

10. The vehicle of claim 8, wherein the hoisting plate including a flange to secure the hoisting plate with the vehicle.

11. The vehicle of claim 10, wherein the hoisting plate includes a projecting beam to be received by the jack.

12. The vehicle of claim 8, wherein two brackets are included.

13. The vehicle of claim 8, wherein each bracket has an overall U-shape with L-shaped legs providing a spaced web to receive the hoisting plate, and each leg including a securement flange for coupling with the tread plate.

14. The vehicle of claim 8, further including at least one L-shaped secondary support bracket secured with the tread plate and for securing with the vehicle.
